(19) United States
(12) Patent Application Publication
(10) Pub. No.: US 2010/0145586 A1
(43) Pub. Date: Jun. 10, 2010

(54) METHOD FOR CONTROLLING THE TORQUE CONVERTER CLUTCH (TCC) PRESSURE DURING COAST DOWNSHIFT EVENTS

(75) Inventor: Vincent HOLTZ, Roshenwiller (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/626,111

(22) Filed: Nov. 25, 2009

(30) Foreign Application Priority Data
Dec. 5, 2008 (GB) 0822210.1

(51) Int. Cl. G06F 17/00

(52) U.S. Cl. 701/68

(57) ABSTRACT

A method is provided for controlling the torque converter clutch (TCC) pressure during coast downshift events. In order to provide a method for controlling the TCC pressure during coast downshift events, it is proposed that coast pressure compensation is computed at the beginning of the shift and that the coast pressure compensation is applied on the TCC pressure during the coast downshift. With such pressure compensation it is possible to stay in regulation mode which improves both shift quality and fuel consumption.

### CROSS-REFERENCE TO RELATED APPLICATION

This application claims priority to British Patent Application No. 0822210.1, filed Dec. 5, 2008, which is incorporated herein by reference in its entirety.

### TECHNICAL FIELD

The invention relates to a method for controlling the torque converter clutch (TCC) pressure during coast downshift events.

### BACKGROUND

Coast downshift events are downshifts without throttle or with low percentage (in general up to 3 or 4 percent of throttle).

According to the prior art, the TCC pressure was released during coast downshift events, which means that there was no regulation of the TCC slip (difference between the engine speed and the turbine speed). In consequence, there was a high amount of TCC slip dissipating a lot of energy which increases fuel consumption. Driving comfort is also impacted since there is no engine braking which is not acceptable especially for European drivers.

It is therefore at least one objective of the invention to provide a method for controlling the torque converter clutch (TCC) pressure during coast downshift events. In addition, other objectives, desirable features and characteristics will become apparent from the subsequent summary and detailed description, and the appended claims, taken in conjunction with the accompanying drawings and this background.

### SUMMARY

The at least one objective, other objectives, desirable features, and characteristics, are achieved according to an embodiment of the present invention in that a coast pressure compensation is computed at the beginning of the shift and that the coast pressure compensation is applied on the TCC pressure during the coast downshift.

The pressure compensation is applied directly to the TCC pressure determined by the normal algorithm in TCC CoastOn and CoastLockOn modes. With such a pressure compensation it is possible to stay in regulation mode during the closed throttle downshift. This will avoid releasing the TCC before the shift, being off during the shift and reapplying TCC when the shift is finished. It improves both shift quality and fuel consumption.

According to an embodiment of the present invention, the pressure compensation is based on a 3D table function of Turbine Speed and Turbine Speed Accel with:

$$Turbine Speed Accel = \frac{\begin{matrix}Commanded Gear Turbine - \\ Attained Gear Turbine\end{matrix}}{Desired ShiftTime}$$

In a first embodiment of the invention, TCC operating pressure is ramped down to TCC compensated pressure and then the TCC compensated pressure is maintained until the end of the downshift. In this context, the ramp slopes can be modified via calibration.

In a second configuration, TCC pressure is maintained at the uncompensated level during delay phase, decreased instanteneously at the beginning of the time phase, maintained at the compensated TCC pressure during time phase and end phase and the ramped up to the uncompensated pressure level.

In this second configuration, the pressure compensation is operated down during time phase and end phase and then the pressure is ramped up from the compensated TCC pressure to the normal operating pressure. In the second configuration, the ramp slope can be modified via calibration. It will depend on the shift type whether the first or the second configuration of the pressure compensation is applied.

According to an other embodiment of the invention, the first level of compensation is stored if another downshift is commanded before the compensation of the first shift is terminated, the second shift variables are updated and TCC pressure is ramped directly form the stored first level of compensation to the second compensated pressure level.

Instead of ramping up to the normal TCC pressure at the end of the first shift and ramping down to the compensated pressure level of the second downshift, the level of pressure compensation is maintained, the second shift variables are updated and the TCC pressure is then ramped down from the maintained level to the second compensated pressure level. This avoids undesired steps of pressure due to the chained downshifts.

In a further embodiment of the invention, a peak of pressure compensation is provided in order to compensate undesired peaks of pressure.

### BRIEF DESCRIPTION OF THE DRAWINGS

The present invention will hereinafter be described in conjunction with the following drawing figures, wherein like numerals denote like elements, and

FIG. 1 shows a schematic representation of the pressure compensation according to an embodiment of the present invention;

FIG. 2 show a representation of factors taken into account for computing the pressure compensation; and

FIG. 3 shows a typical inertia compensation scenario with two chained power downshifts.

### DETAILED DESCRIPTION

The following detailed description is merely exemplary in nature and is not intended to limit application and uses. Furthermore, there is no intention to be bound by any theory presented in the preceding background or summary or the following detailed description.

Referring to FIG. 1, the pressure compensation is computed at the beginning of the shift using several timing information coming from clutch control algorithms. The pressure compensation is applied directly to the TCC pressure determined by the normal algorithm in TCC CoastOn and CoastLockOn modes.

Different pressure compensation options can be triggered via calibration. Two pressure compensation options referenced “Case 01” and “Case 02” are shown in FIG. 1 and described in the following.

In Case 01, the TCC operating pressure is ramped down to the compensated pressure level, i.e. from the uncompensated TCC pressure level to the compensated TCC pressure level.

When the ramp has reached the compensated level, the TCC pressure remains at the compensated TCC pressure level.

Finally, when the closed throttle downshift is finished, the TCC pressure ramps up to the uncompensated TCC pressure level.

The slopes for ramping down and ramping up the TCC pressure can be modified via calibration.

In Case 02, the TCC pressure is maintained at the uncompensated TCC pressure level during the delay phase.

At the end of the delay phase, TCC pressure is decreased instantaneously to the compensated TCC pressure level.

The TCC pressure is then maintained over the time phase and the end phase.

Finally, TCC pressure is ramped up from the compensated pressure level to the uncompensated pressure level when the closed throttle downshift is finished. The slope for ramping up the TCC pressure can be modified via calibration.

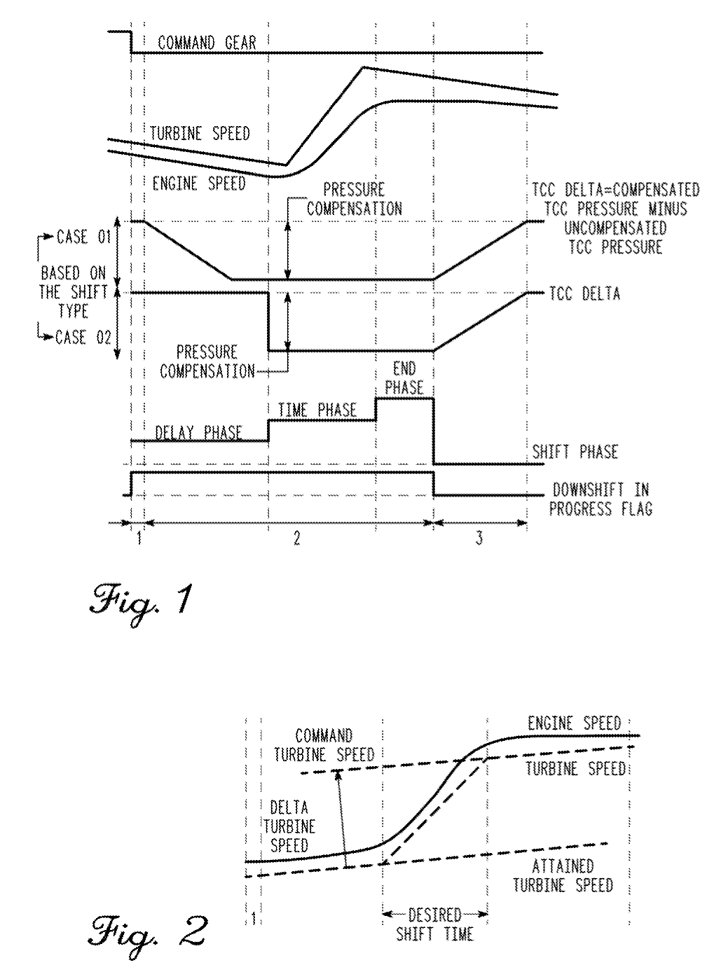

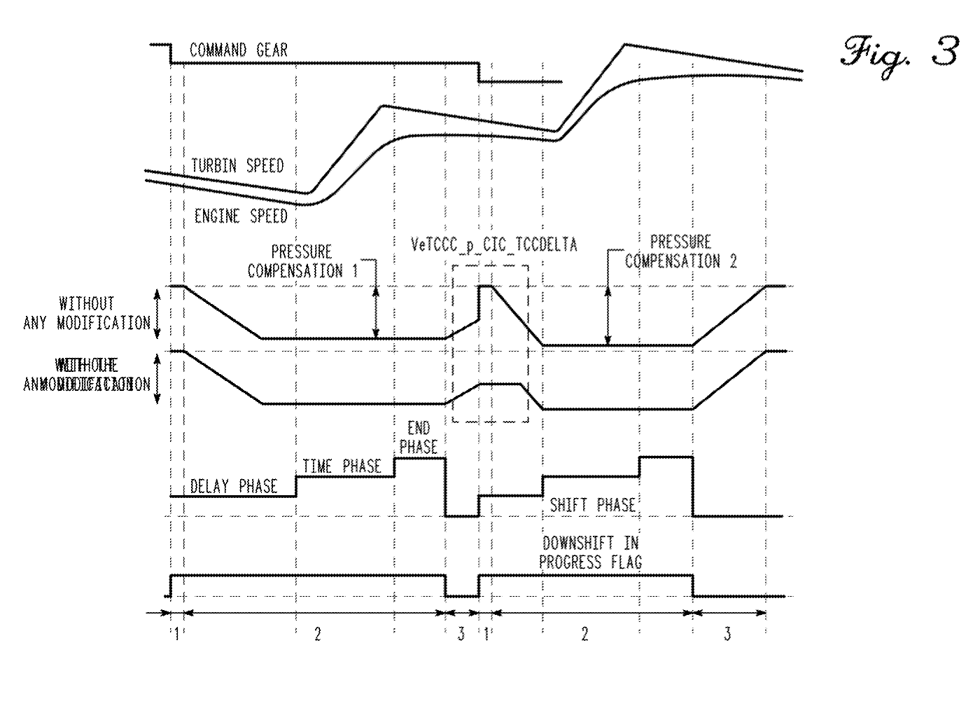

FIG. 2 shows a graphic representation of some factors used for computing the pressure compensation. The engine speed increases during the shift operation. The delta turbine speed is the difference between the commanded turbine speed and the attained turbine speed. During the desired shift time, the turbine speed increases from the attained turbine speed to the commanded turbine speed.

It is to be noted that several conditions have to be fulfilled in order to launch the update function; update is only possible in the shift delay phase, update is only possible if the variables for this shift have not already been updated, update is only possible if a downshift is in progress, and update is only possible if an update is allowed.

When an update is allowed, the real update is performed only after an amount of time to ensure that all the information to be retrieved from the clutch control algorithm has been updated.

It is further useful to handle chained downshifts in a smart way. Instead of ramping up to the uncompensated TCC pressure at the end of the first shift and ramping down to the compensated TCC pressure level of the second shift, it is possible to detect if a second shift has been commanded. If another shift has been commanded and the pressure compensation of the first shift is about to be finished, the first level of compensation is stocked, the second shift variables are updated and TCC pressure is ramped down directly from the stored first level of compensation to the second TCC compensated pressure level as shown in FIG. 3.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for controlling a torque converter clutch (TCC) pressure during a coast downshift event, comprising the steps of:
computing a coast pressure compensation at a beginning of a shift; and
applying the coast pressure compensation on the TCC pressure during the coast downshift event.

2. The method of claim 1, wherein in the coast pressure compensation is based on a 3D table function of a Turbine Speed and a Turbine Speed Accel, wherein with:
$$Turbine Speed Accel = \frac{\begin{matrix}Commanded Gear Turbine - \\ Attained Gear Turbine\end{matrix}}{Desired ShiftTime}$$

3. The method of claim 1, wherein a TCC operating pressure is ramped down to a TCC compensated pressure and then the TCC compensated pressure is maintained until an end of a downshift.

4. The method of claim 3, wherein the ramped down has a slopes that can be modified via a calibration.

5. The method of claim 1, wherein TCC pressure is maintained at an uncompensated pressure level during a delay phase, decreased instanteneously at a beginning of a time phase, maintained at a compensated TCC pressure during the time phase and an end phase, and the ramped up to the uncompensated pressure level.

6. The method of claim 5, wherein the slope can be modified via a calibration.

7. The method of claim 1, wherein a first level of compensation is stored if another downshift is commanded before the compensation of a first shift is terminated, a second shift variable is updated and TCC pressure is ramped directly form a stored first level of compensation to a second compensated pressure level.

8. The method of claim 1, wherein a peak of pressure compensation is provided in order to compensate undesired peaks of pressure.
